(19) United States
(12) Patent Application Publication
(10) Pub. No.: US 2013/0268523 A1
(43) Pub. Date: Oct. 10, 2013

(54) SYSTEM AND METHOD FOR DETERMINING USER OR RESOURCE INFLUENCE WITHIN A PRE-DEFINED CONTEXT

(71) Applicant: MYSPACE LLC, Beverly Hills, CA (US)

(72) Inventors: Michael Scott Andler, Los Angels, CA (US); James Andrew Beaupre, Los Angeles, CA (US); Eric J. Kim, Tujunga, CA (US); Thomas B. Werz, III, Los Angeles, CA (US)

(73) Assignee: MySpace LLC, Beverly Hills, CA (US)

(21) Appl. No.: 13/858,720

(22) Filed: Apr. 8, 2013

Related U.S. Application Data
(60) Provisional application No. 61/621,051, filed on Apr. 6, 2012.

(51) Int. Cl. G06F 17/30

(52) U.S. Cl. CPC G06F 17/30528
USPC 707/723

(57) ABSTRACT

A method, system, apparatus, and computer program product provides the ability to determine the influence of a user or resource within a pre-defined context. A pre-defined context of activities is provided/defined. Point values are assigned to all activities that may occur within the pre-defined context. All activities for a single user or resource within the pre-defined context are tracked over a period of time. A score value for each activity for the single user or resource within the pre-defined context over a period of time is determined. A raw score is calculated for the single user or resource according to the total of all determined score values. The raw score value is normalized against scores of a population of other users or resources within the pre-determined context to provide a comparative scoring for users or resources.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Application Ser. No. 61/621,051, filed on Apr. 6, 2012, by Mike Andler, James Andrew Beaupre, Eric Juhyun Kim, and Thomas Barraud Werz III, entitled “System and Method for Determining User or Resource Influence within a Pre-Defined Context”, attorneys' docket number 257.43-US-P1

This application is related to the following co-pending and commonly-assigned patent application(s), which is/are incorporated by reference herein:

U.S. patent application Ser. No. 13/528,368 filed on Jun. 20, 2012, entitled “System and Method for Determining the Relative Ranking of a Network Resource” by Thomas B. Werz III, James Beaupre, and Eric J. Kim, attorneys' docket number 257.33-US-U1, which application claims the benefit of U.S. Provisional Patent Application Ser. No. 61/498,666, filed on Jun. 20, 2011, by Thomas B. Werz III, James A. Beaupre, and Eric J. Kim, entitled “System and Method Determining the Relative Ranking of a Network Resource in a Distributed Environment”,” attorneys' docket number 257.33-US-P1;

U.S. patent application Ser. No. 13/528,679, filed on Jun. 20, 2012, by Thomas B. Werz III, James A. Beaupre, and Eric J. Kim, entitled “System and Method of Tracking User Interaction with Content”, attorneys' docket number 257.39-US-U1, which application claims the benefit of United States Provisional Application Ser. No. 61/498,674, filed on Jun. 20, 2011, by Thomas B. Werz III, James A. Beaupre, and Eric J. Kim, entitled “System and Method of Tracking User Interaction with Content”, attorneys' docket number 257.39-US-P1;

United States patent application Serial No. XX/YYY,ZZZ, filed on Apr. 8, 2013, by Michael Scott Andler, James A. Beaupre, Eric J. Kim, and Thomas B. Werz III, entitled “System and Method for Presenting and Managing Social Media”, attorneys' docket number 257.40-US-U1, which application claims the benefit of U.S. Provisional Patent Application Ser. No. 61/621,057 filed on Apr. 6, 2012, entitled “System and Method for Presenting and Managing Social Media” by Mike Andler, James Andrew Beaupre, Eric Juhyun Kim, and Thomas Barraud Werz III, attorneys' docket number 257.40-US-P1; and

United States patent application Serial No. XX/YYY,ZZZ, filed on Apr. 8, 2013, by Michael Scott Andler, James A. Beaupre, Eric J. Kim, and Thomas B. Werz III, entitled “System and Method for Recommending Content”, attorneys' docket number 257.44-US-U1, which application claims the benefit of U.S. Provisional Application Ser. No. 61/621,049, filed on Apr. 6, 2012, by Mike Andler, James Andrew Beaupre, Eric Juhyun Kim, and Thomas Barraud Werz III, entitled “System and Method for Recommending Content”, attorneys' docket number 257.44-US-P1.

U.S. patent application Ser. No. 13/786,173, filed on Mar. 5, 2013, by Jason J. A. Knapp, entitled “User and Content Recommendation and Discovery Application”, attorneys' docket number 257.8-US-U1, which application claims the benefit of U.S. Patent Application Ser. No. 61/606,869, entitled “User and Content Recommendation and Discovery Application”, by Jason J. A. Knapp, filed on Mar. 5, 2012, Attorney Docket No. 257.8-US-P1.

### BACKGROUND OF THE INVENTION

1. Field of the Invention

This invention relates generally to methods and systems for determining user or resource influence within a pre-defined context (e.g., within a social network or other defined scope of activities).

2. Description of the Related Art

Currently, systems and methods of tracking users or resources (e.g., on a social networking site or across another defined scope of activities) lack the ability to effectively determine and track the influence of a user or resource within that context. With the example of social networking sites, such sites can and do determine generally whether a user or resource is currently trending, however these systems lack comprehensive comparative mechanisms for accurately determining the true influence, good, bad or average, of a user or resource within the context of the entire site.

Accordingly, there is a need in the art for a system and method for accurately determining a user or resource influence within a pre-defined context.

### SUMMARY OF THE INVENTION

The above described and other problems and disadvantages of the prior art are overcome and alleviated by the present system and method of determining the influence of a user or resource within a pre-defined context. In exemplary embodiments, systems and methods described herein assign point values to all activities that may occur within that pre-defined context. In exemplary embodiments, the systems and methods are thus used to determine a user's or resource's global popularity, relevance, and/or desirability based on activities it is or has been associated with.

In further exemplary embodiments, such determinations may be made over discrete time intervals or in real time across all activities associated with the user or resource. In other exemplary embodiments, such determinations may be made in category specific contexts, including but not limited to a social networking site, point based contests, promotions, games and marketing, among other examples.

In other exemplary embodiments, the systems and methods provide weighted scores users or resources, such that activities associated with higher scored users or resources affect other users or resources more significantly than lower rated users or resources. Exemplary embodiments also provide awards to higher scored users or resources, for example by way of increased usage opportunity, marketing advantages, feature targeting and higher visibility to the masses, among others.

In another exemplary embodiment, such systems and methods provide a frame score for a user or resource on a social networking site by assigning such point values to all activities on the social networking site. As in other exemplary embodiments, an exemplary weighted scoring may be utilized to allow more famous users or resources to affect the scores of other users or resources more significantly than less famous users or resources, thus rewarding the importance of celebrity influence and organic global reach.

The above discussed and other features and advantages of the present invention will be appreciated and understood by those skilled in the art from the following detailed description and drawings.

### BRIEF DESCRIPTION OF THE DRAWINGS

Referring now to the drawings in which like reference numbers represent corresponding parts throughout:

FIG. 1 illustrates an exemplary method of determining the influence of a user or resource within a pre-defined context in accordance with one or more embodiments of the invention;

FIGS. 2-4 show exemplary user interfaces where a frame score is displayed in association with a video playing back within a stream in accordance with one or more embodiments of the invention;

FIG. 5 is an exemplary hardware and software environment used to implement one or more embodiments of the invention; and

FIG. 6 schematically illustrates a typical distributed computer system using a network to connect client computers to server computers in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention. Embodiments of the invention include systems and methods for presenting and managing social media that utilize one or more of various subsystems. Exemplary subsystems will be described in turn, followed by a discussion of their context in the system architecture and a discussion of system and method flow.

### Frame Score—a System and Method for Determining User or Resource Influence Within a Pre-Defined Context

As described herein, example embodiments of the present invention may include systems and methods of determining the influence of a user or resource within a pre-defined context (also referred to as a user's frame). In exemplary embodiments, systems and methods described herein assign point values to all activities that may occur within that pre-defined context. In exemplary embodiments, the systems and methods are thus used to determine a user's or resource's global popularity, relevance, and/or desirability based on activities it is or has been associated with.

Thus, exemplary embodiments advantageously provide a uniform scoring mechanism by which any and all activities occurring within a global system can be rated, judged or defined in a mathematical and uniform manner.

In further exemplary embodiments, such determinations may be made over discrete time intervals or in real time across all activities associated with the user or resource. In other exemplary embodiments, such determinations may be made in category specific contexts, including but not limited to a social networking site, point based contests, promotions, games and marketing, among other examples.

In other exemplary embodiments, the systems and methods provide/assign weighted scores to users or resources, such that activities associated with higher scored users or resources affect other users or resources more significantly than lower rated users or resources. Exemplary embodiments also provide awards to higher scored users or resources, for example by way of increased usage opportunity, marketing advantages, feature targeting and higher visibility to the masses, among others.

In another exemplary embodiment, such systems and methods provide a frame score for a user or resource on a social networking site by assigning such point values to all activities on the social networking site. As in other exemplary embodiments, an exemplary weighted scoring may be utilized to allow more famous users or resources to affect the scores of other users or resources more significantly than less famous users or resources, thus rewarding the importance of celebrity influence and organic global reach.

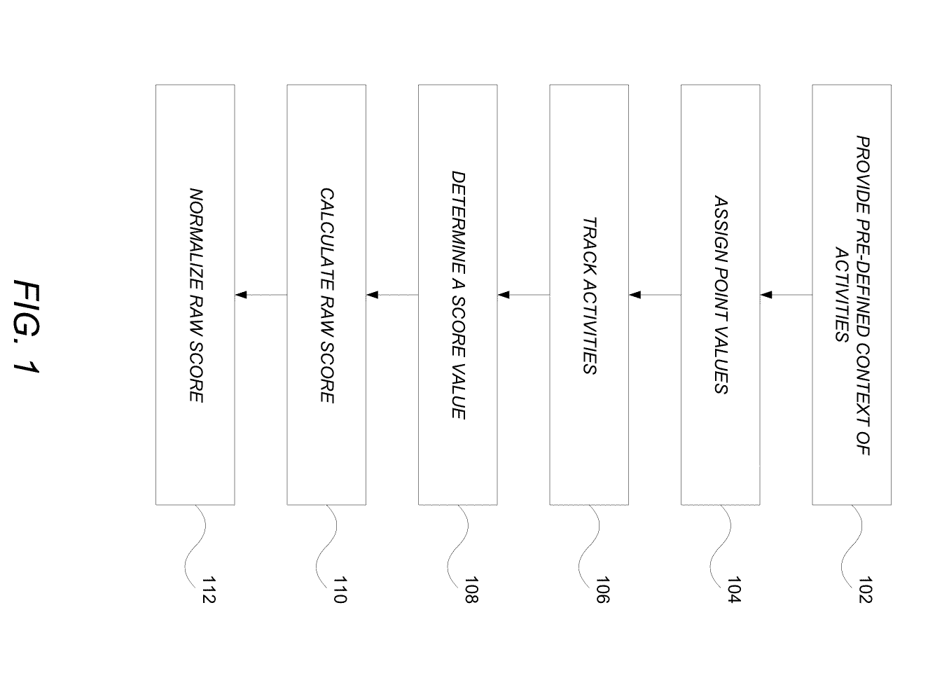

FIG. 1 illustrates an exemplary method of determining the influence of a user or resource within a pre-defined context in accordance with one or more embodiments of the invention. The determined influence may be used to gauge or identify a user/resource's global popularity, relevance, and/or desirability based on activities the user/resource has been associated with.

At step 102, a pre-defined context of activities is provided. Such a pre-defined context defines the bounds for determining the influence of a user. For example, the pre-defined context may be category specific such as across a social network site, within a point-based contest, within a promotion/promotional activity, within a game and/or marketing, etc.

At step 104, point values are assigned to all activities that may occur within that pre-defined context. Examples of such activities include anything that a user does relative to another person, object, etc.

As used herein, an activity can be defined as any and all interactions that may occur in the pre-defined context. For example, on a network site, such activities can include anything that a user does relative to another person, object, uniquely identifiable resource, etc., or vice versa. Examples of user activities may include clicking through an advertisement, adding a new friend of a social network, expanding a social network, posting real user activities (e.g., status updates, events, etc), uploading and/or sharing multimedia, sharing photos, sharing video, sharing music, or any other suitable activity. Furthermore, user activities may include clicking, accessing, or sharing content already uploaded to the website. For example, a user may access video, music, or any other suitable material posted by a friend or member of a social network, and thus these activities may be tracked. Additionally, a user may click a shared web-link, URL, or other dynamic content previously posted, and thus these activities may also be tracked. Moreover, any other useful or meaningful user activity including new user registration, increasing/decreasing number of friends, web sales, photo deletion, content removal, etc. may also be tracked. It is also noted that the activities described above are only examples of possible activities to be tracked, and should not be construed as limiting.

In view of the above, a point value (e.g., 1, 2, etc.) may be assigned to each activity. Certain activities may have a higher point value than other activities. For example, on a social network site, sharing music/video may have a higher point value than merely adding a new friend. Accordingly, the point values serve to identify the intrinsic value of an activity. In addition, the point values may vary depending on both the pre-defined context as well as the frequency of the activity. For example, if a user has 5000 friends, adding another friend may not be associated with as high a point value compared to a user that only has 10 friends. Similarly, if a user shares a song/music 100 times in a day, the music sharing activity may not have as high a point value compared to a user that only shares 2 songs over the same time period. In this regard, the point values may be defined on a scale that varies based on the context and frequency.

At step 106, all activities for a single user or resource within the pre-defined context are tracked over a period of time (e.g., a discrete time interval or in real-time across all activities associated with the user or resource).

At step 108, a score value for each activity for the single user or resource within the pre-defined context over a period of time is determined (e.g., based on the point values).

At step 110, a raw score is calculated for the single user or resource according to the total of all of the determined score values.

At step 112, the raw score value is normalized against scores of a population of other users or resources within the pre-determined context to provide a comparative scoring for users or resources within the pre-defined context.

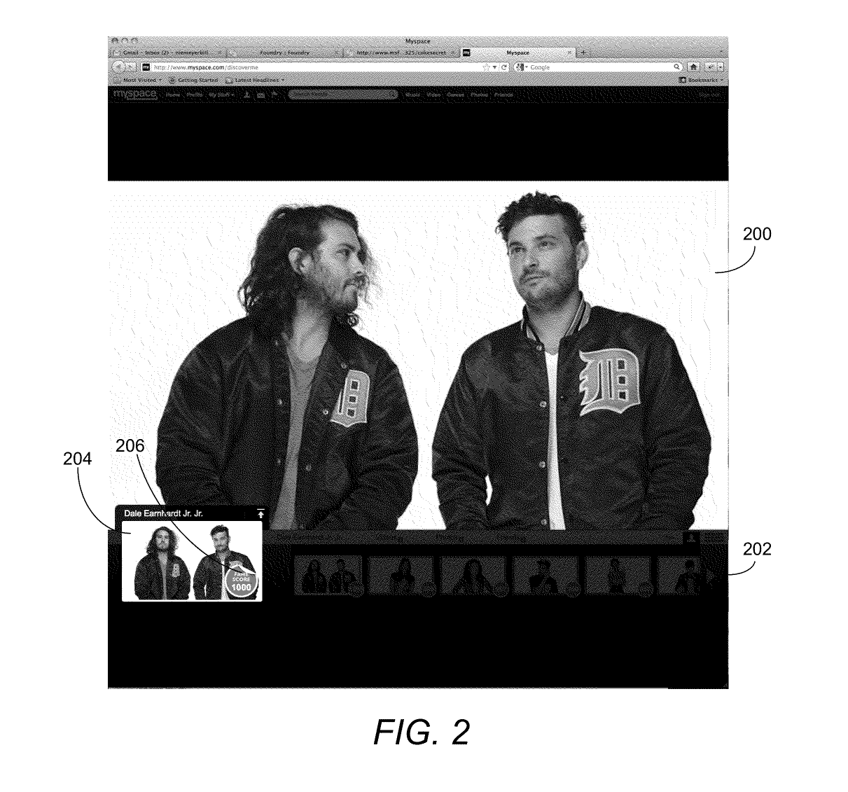

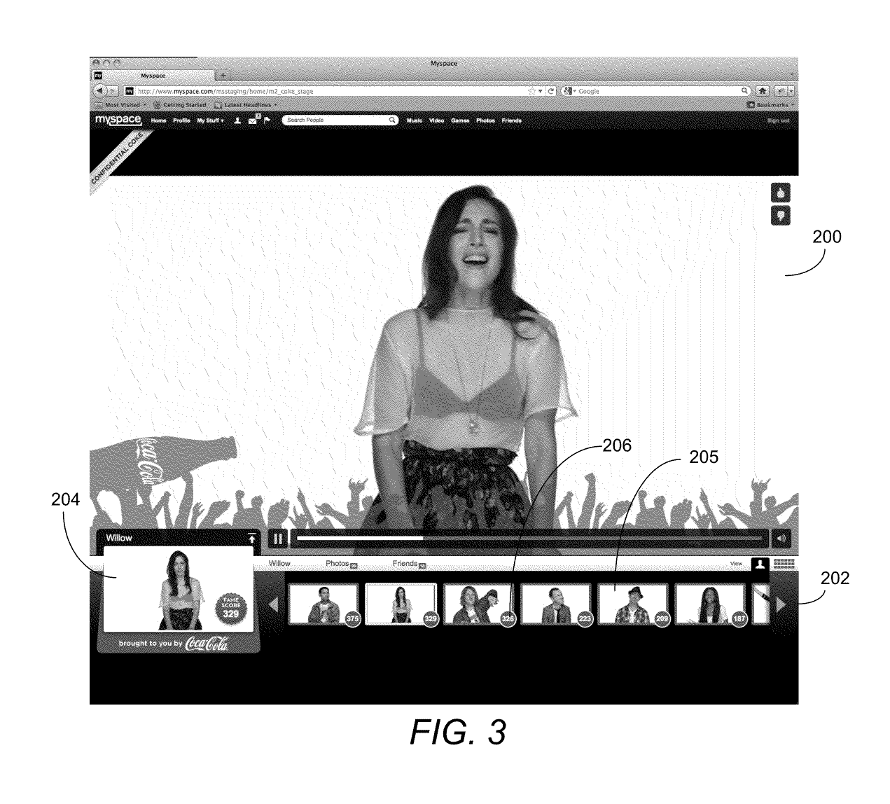

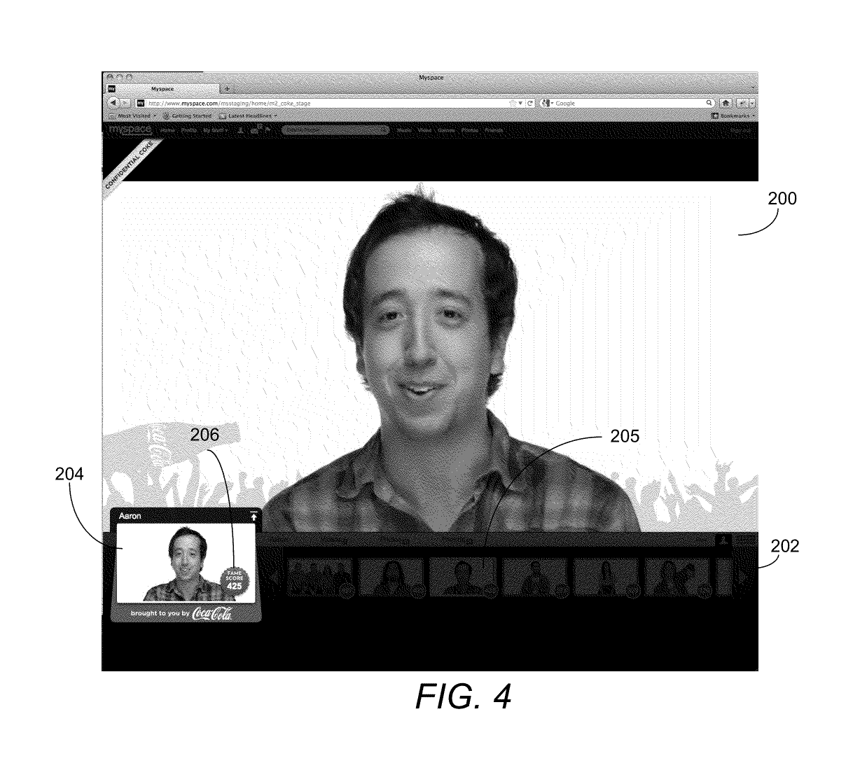

Once a frame score (e.g., the normalized score) has been computed, various embodiments of the invention may opt to utilize the score. Such a utilization may include determining/providing advertising based on the score, providing benefits to users with certain scores (e.g., monetary benefit, awards, rewards, etc.). Alternatively, the utilization may include displaying the score in association with the relevant user/content. FIGS. 2-4 show exemplary user interfaces where a frame score is displayed in association with a video 200 playing back within a stream. The queue of content to be displayed is illustrated in playback bar 202. A pop-up window 204 provides further information about the current video 200 in the playback bar 202 being viewed. Additional icons in the playback bar 200 may indicate the entire queue of video content (e.g., past, current, and future) to be displayed. Within pop-up window 204 and the icons 205 in the playback bar/queue 202, a frame score 206 may be displayed. Such a frame score 206 is relevant to the content or the user responsible for the content.

### Hardware Environment

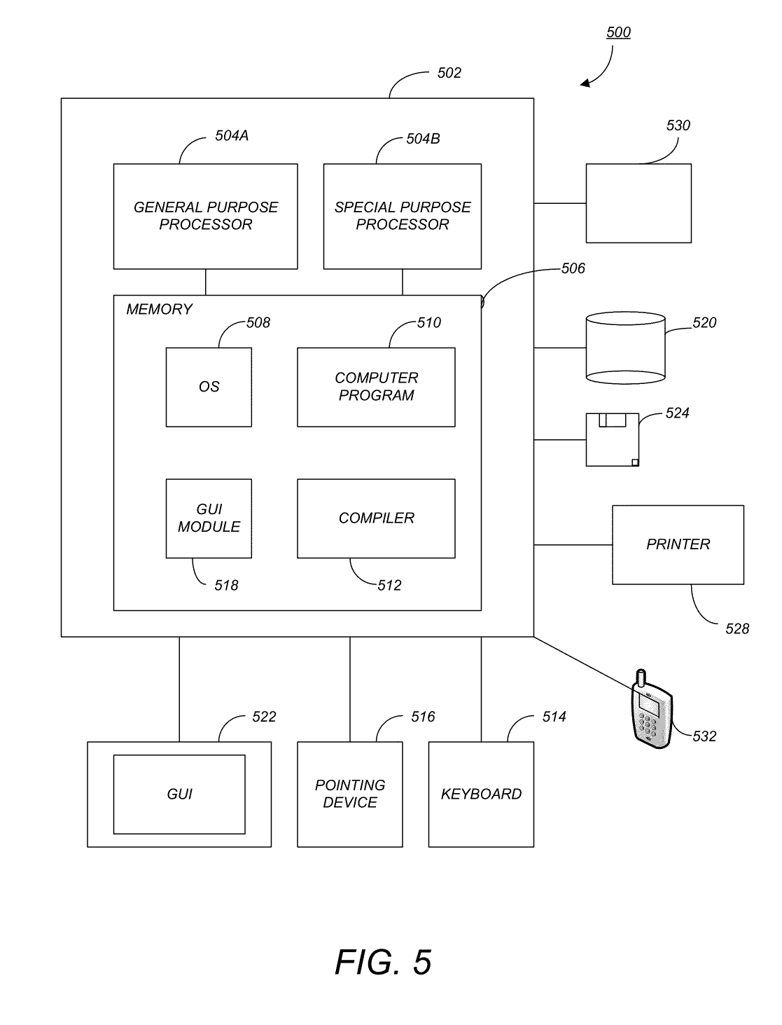

FIG. 5 is an exemplary hardware and software environment 500 used to implement one or more embodiments of the invention. The hardware and software environment includes a computer 502 and may include peripherals. Computer 502 may be a user/client computer, server computer, or may be a database computer. The computer 502 comprises a general purpose hardware processor 504A and/or a special purpose hardware processor 504B (hereinafter alternatively collectively referred to as processor 504) and a memory 506, such as random access memory (RAM). The computer 502 may be coupled to, and/or integrated with, other devices, including input/output (I/O) devices such as a keyboard 514, a cursor control device 516 (e.g., a mouse, a pointing device, pen and tablet, touch screen, multi-touch device, etc.) and a printer 528. In one or more embodiments, computer 502 may be coupled to, or may comprise, a portable or media viewing/listening device 532 (e.g., an MP3 player, iPod™, Nook™, portable digital video player, cellular device, personal digital assistant, etc.). In yet another embodiment, the computer 502 may comprise a multi-touch device, mobile phone, gaming system, internet enabled television, television set top box, or other internet enabled device executing on various platforms and operating systems.

In one embodiment, the computer 502 operates by the general purpose processor 504A performing instructions defined by the computer program 510 under control of an operating system 508. The computer program 510 and/or the operating system 508 may be stored in the memory 506 and may interface with the user and/or other devices to accept input and commands and, based on such input and commands and the instructions defined by the computer program 510 and operating system 508, to provide output and results.

Output/results may be presented on the display 522 or provided to another device for presentation or further processing or action. In one embodiment, the display 522 comprises a liquid crystal display (LCD) having a plurality of separately addressable liquid crystals. Alternatively, the display 522 may comprise a light emitting diode (LED) display having clusters of red, green and blue diodes driven together to form full-color pixels. Each liquid crystal or pixel of the display 522 changes to an opaque or translucent state to form a part of the image on the display in response to the data or information generated by the processor 504 from the application of the instructions of the computer program 510 and/or operating system 508 to the input and commands. The image may be provided through a graphical user interface (GUI) module 518. Although the GUI module 518 is depicted as a separate module, the instructions performing the GUI functions can be resident or distributed in the operating system 508, the computer program 510, or implemented with special purpose memory and processors.

In one or more embodiments, the display 522 is integrated with/into the computer 502 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 502 according to the computer program 510 instructions may be implemented in a special purpose processor 504B. In this embodiment, the some or all of the computer program 510 instructions may be implemented via firmware instructions stored in a read only memory (ROM), a programmable read only memory (PROM) or flash memory within the special purpose processor 504B or in memory 506. The special purpose processor 504B may also be hardwired through circuit design to perform some or all of the operations to implement the present invention. Further, the special purpose processor 504B may be a hybrid processor, which includes dedicated circuitry for performing a subset of functions, and other circuits for performing more general functions such as responding to computer program 510 instructions. In one embodiment, the special purpose processor 504B is an application specific integrated circuit (ASIC).

The computer 502 may also implement a compiler 512 that allows an application or computer program 510 written in a programming language such as COBOL, Pascal, C++, FORTRAN, or other language to be translated into processor 504 readable code. Alternatively, the compiler 512 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 510 accesses and manipulates data accepted from I/O devices and stored in the memory 506 of the computer 502 using the relationships and logic that were generated using the compiler 512.

The computer 502 also optionally comprises an external communication device such as a modem, satellite link, Ethernet card, or other device for accepting input from, and providing output to, other computers 502.

In one embodiment, instructions implementing the operating system 508, the computer program 510, and the compiler 512 are tangibly embodied in a non-transient computer-readable medium, e.g., data storage device 520, which could include one or more fixed or removable data storage devices, such as a zip drive, floppy disc drive 524, hard drive, CD-ROM drive, tape drive, etc. Further, the operating system 508 and the computer program 510 are comprised of computer program 510 instructions which, when accessed, read and executed by the computer 502, cause the computer 502 to perform the steps necessary to implement and/or use the present invention or to load the program of instructions into a memory 506, thus creating a special purpose data structure causing the computer 502 to operate as a specially programmed computer executing the method steps described herein. Computer program 510 and/or operating instructions may also be tangibly embodied in memory 506 and/or data communications devices 530, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 502.

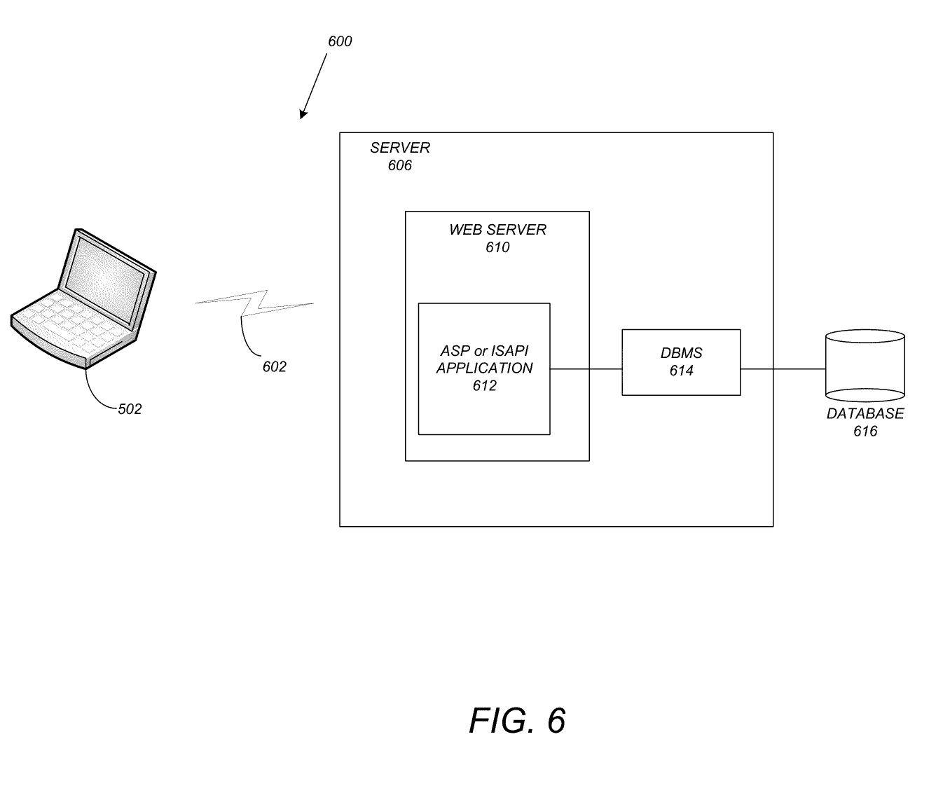

FIG. 6 schematically illustrates a typical distributed computer system 600 using a network 604 to connect client computers 502 to server computers 606. A typical combination of resources may include a network 604 comprising the Internet, LANs (local area networks), WANs (wide area networks), SNA (systems network architecture) networks, or the like, clients 502 that are personal computers or workstations (as set forth in FIG. 5), and servers 606 that are personal computers, workstations, minicomputers, or mainframes (as set forth in FIG. 5). However, it may be noted that different networks such as a cellular network (e.g., GSM [global system for mobile communications] or otherwise), a satellite based network, or any other type of network may be used to connect clients 502 and servers 606 in accordance with embodiments of the invention.

A network 604 such as the Internet connects clients 502 to server computers 606. Network 604 may utilize ethernet, coaxial cable, wireless communications, radio frequency (RF), etc. to connect and provide the communication between clients 502 and servers 606. Clients 502 may execute a client application or web browser and communicate with server computers 606 executing web servers 610. Such a web browser is typically a program such as MICROSOFT INTERNET EXPLORER™, MOZILLA FIREFOX™, OPERA™, APPLE SAFARI™, GOOGLE CHROMET™, etc. Further, the software executing on clients 502 may be downloaded from server computer 606 to client computers 502 and installed as a plug-in or ACTIVEX™ control of a web browser. Accordingly, clients 502 may utilize ACTIVEX™ components/component object model (COM) or distributed COM (DCOM) components to provide a user interface on a display of client 502. The web server 610 is typically a program such as MICROSOFT'S INTERNET INFORMATION SERVER™.

Web server 610 may host an Active Server Page (ASP) or Internet Server Application Programming Interface (ISAPI) application 612, which may be executing scripts. The scripts invoke objects that execute business logic (referred to as business objects). The business objects then manipulate data in database 616 through a database management system (DBMS) 614. Alternatively, database 616 may be part of, or connected directly to, client 502 instead of communicating/obtaining the information from database 616 across network 604. When a developer encapsulates the business functionality into objects, the system may be referred to as a component object model (COM) system. Accordingly, the scripts executing on web server 610 (and/or application 612) invoke COM objects that implement the business logic. Further, server 606 may utilize MICROSOFT'S™ Transaction Server (MTS) to access required data stored in database 616 via an interface such as ADO (Active Data Objects), OLE DB (Object Linking and Embedding DataBase), or ODBC (Open DataBase Connectivity).

Generally, these components 600-616 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 502 and 606 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 502 and 606.

### Software Embodiment Overview

Embodiments of the invention are implemented as a software application on a client 502 or server computer 606. Further, as described above, the client 502 or server computer 606 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 502, portable device, etc.

As described above, client 502 or server computer 606 may integrate and provide the capabilities described in FIGS. 1-6. In this regard, the platform and processing capabilities that provide the ability to present and manage social media may be performed by client 502, server 606, and/or a combination of client 502 and/or server 606.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for determining the influence of a user or resource within a pre-defined context, comprising:
providing, in a computer, a pre-defined context of activities;
assigning, in the computer, point values to all activities that may occur within that pre-defined context;
tracking, in the computer, all activities for a single user or resource within said pre-defined context over a period of time;
determining, in the computer, a score value for each activity for said single user or resource within said pre-defined context over a period of time;
calculating, in the computer, a raw score for said single user or resource according to the total of all said determined score values; and
normalizing, in the computer, that raw score value against scores of a population of other users or resources within said pre-determined context to provide a comparative scoring for users or resources within said pre-defined context.

2. The computer-implemented method of claim 1, wherein said comparative scoring is representative of a user's or resource's global popularity based on activities the user or resource is or has been associated with.

3. The computer-implemented method of claim 1, wherein said comparative scoring is representative of a user's or resource's relevance based on activities the user or resource is or has been associated with.

4. The computer-implemented method of claim 1, wherein said comparative scoring is representative of a user's or resource's desirability based on activities the user or resource is or has been associated with.

5. The computer-implemented method of claim 1, wherein said determining is performed in real time across all activities associated with the user or resource.

6. The computer-implemented method of claim 1, wherein said pre-defined context comprises a social networking site.

7. The computer-implemented method of claim 1, wherein said pre-defined context comprises a point based contest.

8. The computer-implemented method of claim 1, wherein said pre-defined context comprises a promotion.

9. The computer-implemented method of claim 1, wherein said pre-defined context comprises a marketing proceeding.

10. The computer-implemented method of claim 1, wherein at least one score value determined for an activity is weighted according to the comparative scoring of a user or resource associated with said activity.

11. The computer-implemented method of claim 1, wherein:
said pre-defined context is a social networking site or subset thereof; and
said comparative scores represent frame scores for individual users or resources on the social networking site.

12. The computer-implemented method of claim 11, wherein at least one score value determined for an activity is weighted according to the frame of a user or resource associated with said activity, such that more famous users or resources affect the scores of other users or resources more significantly than less famous users or resources.

13. A system for presenting media content on a social media network comprising:
a computer;
a pre-defined context of activities stored in the computer;
point values assigned to all activities that may occur within that pre-defined context;
a tracking module, executing in the computer, wherein the tracking module tracks all activities for a single user or resource within said pre-defined context over a period of time; and
a scoring module, executing in the computer, wherein the scoring module:
determines a score value for each activity for said single user or resource within said pre-defined context over a period of time;
calculates a raw score for said single user or resource according to the total of all said determined score values; and
normalizes the raw score value against scores of a population of other users or resources within said pre-determined context to provide a comparative scoring for users or resources within said pre-defined context.

14. The system of claim 13, wherein said comparative scoring is representative of a user's or resource's global popularity based on activities the user or resource is or has been associated with.

15. The system of claim 13, wherein said comparative scoring is representative of a user's or resource's relevance based on activities the user or resource is or has been associated with.

16. The system of claim 13, wherein said comparative scoring is representative of a user's or resource's desirability based on activities the user or resource is or has been associated with.

17. The system of claim 13, wherein the scoring module is configured to perform the determining in real time across all activities associated with the user or resource.

18. The system of claim 13, wherein said pre-defined context comprises a social networking site.

19. The system of claim 13, wherein said pre-defined context comprises a point based contest.

20. The system of claim 13, wherein said pre-defined context comprises a promotion.

21. The system of claim 13, wherein said pre-defined context comprises a marketing proceeding.

22. The system of claim 13, wherein at least one score value determined for an activity is weighted according to the comparative scoring of a user or resource associated with said activity.

23. The system of claim 13, wherein:
said pre-defined context is a social networking site or subset thereof; and
said comparative scores represent frame scores for individual users or resources on the social networking site.

24. The system of claim 23, wherein at least one score value determined for an activity is weighted according to the frame of a user or resource associated with said activity, such that more famous users or resources affect the scores of other users or resources more significantly than less famous users or resources.
